(19) United States
(12) Patent Application Publication
(10) Pub. No.: US 2008/0195896 A1
(43) Pub. Date: Aug. 14, 2008

(54) APPARRATUS AND METHOD FOR UNIVERSAL PROGRAMMABLE ERROR DETECTION AND REAL TIME ERROR DETECTION

(75) Inventors: Lih-Chung Kuo, San Jose, CA (US); Ailoan Thi Tran, San Jose, CA (US); Jianwei Zhuang, San Jose, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/674,775

(22) Filed: Feb. 14, 2007

(51) Int. Cl. G06F 11/00

(52) U.S. Cl. 714/39

(57) ABSTRACT

The present invention relates to a method for the real-time detection and prevention or correction of errors within an IC environment. The method comprises the steps of determining an event, or a sequence of events set, wherein these event set serve as triggers for a defect event within an IC, and configuring a logic analyzer that is embedded within the IC to monitor the operations of the IC in order to detect occurrences of defect event triggers within the IC. Further, the IC defect event trigger information is transmitted from the embedded logic analyzer to an IC hardware sequencer, wherein the hardware sequencer is configured to initiate actions to correct the defect event.

### BACKGROUND OF THE INVENTION

1. Field of the Invention

This invention relates to the field of testing integrated circuits, and particularly to the testing of integrated circuits by logic analyzers that have been embedded within the integrated circuits.

2. Description of Background

Before our invention an integral facet of integrated circuit design and fabrication included the operation of testing an integrated circuit to determine if the circuit performed in accordance with design specifications. In particular, stand alone logic analyzers were utilized to run a succession of digital events upon an integrated circuit system, and subsequently capture the digital data that was generated within the tested integrated circuit system. Initially, logic analyzers were constructed as stand alone devices that could be interfaced within a respective integrated circuit system. Later generations of logic analyzers were constructed in such a manner that they could be situated upon die frames, wherein the logic analyzer could potential monitor the performance characteristics of multiple integrated circuit processing systems.

Currently, as advances in chip technology has made it possible to integrate large numbers of circuits onto a chip, and as more chips are packed onto cards, it has become increasingly difficult to discover all of the design defects within an integrated circuit (IC) during a simulation operation, and additionally during system testing operations. Also, as the cost of fixing design problems by a new release of application-specific integrated chips (ASICs) increase, both in terms of money and time to market, it has become almost cost prohibitive to fix all of the design defects that may exist within an integrated circuit. The cost for fixing design problems may be even more in the event that a design defect is discovered while the IC is operating in the field. Thus, it has become almost an integral production cost strategy to simply work around the design defects that may be discovered as existing within an integrated circuit system.

Therefore, there exists a need for detecting errors that occur within an integrated circuit system, and implementing preventative or correction procedures to remedy such systematic abnormalities.

### SUMMARY OF THE INVENTION

The shortcomings of the prior art are overcome and additional advantages are provided through the provision of a method for the real-time detection and prevention or correction of an error within an IC environment, the method further comprising the steps of determining at least one event, and at least one sequence of events set, wherein the at least one event, and the at least one sequence of events set serve as triggers for a defect event within an IC, and configuring a logic analyzer that is embedded within the IC to monitor the operations of the IC in order to detect occurrences of the at least one event, and the at least one sequence of events set within the IC.

The method further comprises the steps of monitoring an IC for an IC defect event trigger, wherein upon the detection of an IC defect trigger the source of the IC defect event trigger is determined, transmitting the IC defect trigger and IC defect event trigger source information from the embedded logic analyzer to an IC hardware sequencer, and configuring the hardware sequencer to initiate actions to correct the defect event.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a flow diagram detailing aspects of an error detection methodology that may be implemented within embodiments of the present invention.

The detailed description explains the preferred embodiments of the invention, together with advantages and features, by way of example with reference to the drawing.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Detecting systematic IC errors in real time is vital to providing effective real time work around solutions for detected system defect errors. Typically, since there is no prior indication of an IC design defect, it is not known ahead of time what design defect is present within an IC. Further, in some instances errors are not detected at all, or they are detected at a much later time period (e.g., at the system level, as the cause of a hang condition, or being detected by a more general purpose checker such as a timer, CRC check, etc.). In most cases, errors are detected too late to apply a real time work around solution to remedy the errors.

Conventionally, logic analyzers have been widely used to trace logic signals and events for system debugging operations. A logic analyzer trace is triggered by a programmable sequence of events, or signals of interest. As the density of ICs increase, it has been made possible to increase the number of functions and interfaces that are able to fit into such chips. In regard to analyzing the functions of increasingly complicated ICs, the effectiveness of stand along logic analyzers become lessened because they can no longer trigger/trace the ICs internal interfaces and signals. As a solution to these problems, embedded logic analyzer macros have been implemented within many high-density ASIC chips. As an effective debugging tool, embedded logic analyzers are usually connected to, and can monitor any of a plurality of major IC internal interfaces, state machines, or status signals as sources for trigger and trace operations.

Aspects of the present invention relate to the utilization of programmable embedded logic analyzers as universal programmable event detectors. As such, the programmable embedded logic analyzers, upon the detection of an actionable event, are configured to trigger an IC hardware sequencer. Once triggered, the hardware sequencer writes commands to the IC system's control registers to prevent or correct the error that has been caused by the detected defect event.

Within aspects of the present invention logical analyzers are programmed to detect specific defect event conditions or the series of defect event conditions that will result in an impending system defect. An IC hardware sequencer is programmed to respond to triggers that are associated with the specific defect event conditions or the series of defect event conditions that have been programmed within the logical analyzer. Further, the IC hardware sequencer is configured to comprise defect event response code, wherein the defect event response code is associated with and utilized to respond to the respective defect event conditions or the series of defect event conditions that have been programmed within the logical analyzer.

Once programmed to detect specific events, the logic analyzers are configured to monitor the regular operating activities within an IC. Upon the detection of a defect event or a series of defect events, the logic analyzer is further configured to trigger the programmed hardware sequencer to utilize the defect event response code to perform a sequence of preventive or corrective actions.

As presently implemented, a dedicated hardware sequencer is configured to work in conjunction with a processor within an IC system, thereby performing the function of retrieving word data from a micro-program. The hardware sequencer is configured to operate independently of the IC processor. In operation, the hardware sequencer utilizes bits from retrieved word data to control the various components of an IC (e.g., control registers, ALUs, etc.). Within aspects of the present invention the IC processor can be situated externally from the IC or embedded within the IC. Further, the hardware sequencer is interfaced with the processor's control bus, and thus, the processor's control registers. Additionally, the hardware sequencer can subsequently be programmed to write instruction to various control registers via the control bus to perform the required preventive or correction actions.

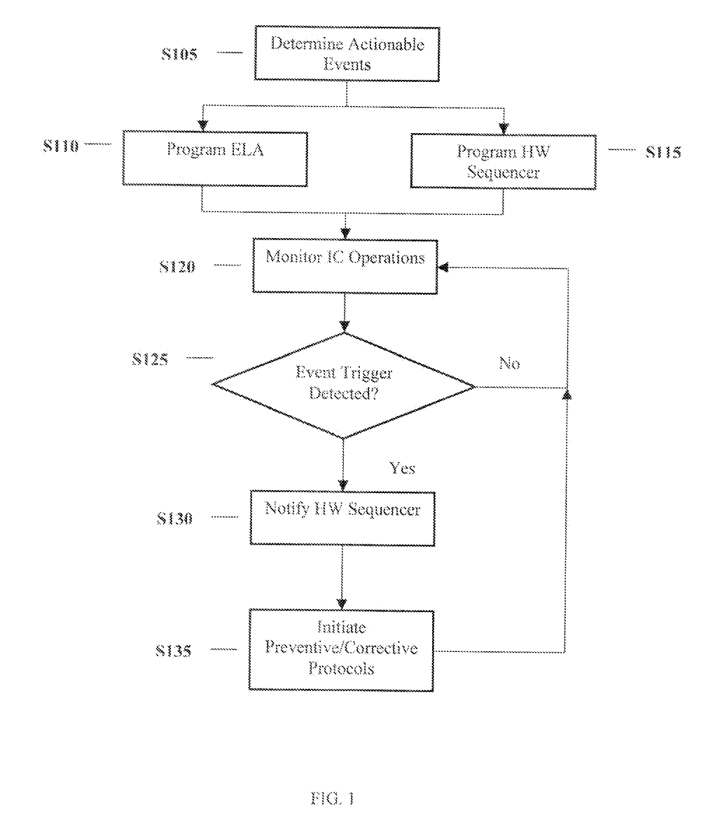

Turning now to the drawings in greater detail, it will be seen that in FIG. 1 there is a flow diagram that illustrates aspects of an embodiment of the present invention. At step 105 a determination is made as to what actionable IC defect events will be monitored by the embedded logic analyzer. At step 110 the logic analyzer is programmed with the information so that the logic analyzer will be able to detect the determined actionable IC defect events conditions. Further, at step 115 the hardware sequencer is programmed to respond to triggers that are associated with the specific determined actionable IC defect events conditions that have been programmed within the logical analyzer.

As part of its programming, the IC hardware sequencer is programmed with defect event response code, wherein the defect event response code is utilized to respond to the respective determined actionable IC defect events conditions that have been programmed within the logical analyzer. Within its operating parameters, the embedded logic analyzer is configured to monitor the ongoing operations of the IC (step 120). If a potential defect event is detected during the routine monitoring operations of the embedded logic analyzer, then at step 125 a determination is made as to if the detected defect event is an actionable defect event. If it is determined that the detected defect event is not an actionable defect event, then the embedded logic analyzer will continue in its normal course of monitoring operation (step 120). If it is determined that the detected defect event is an actionable defect event, then the embedded logic analyzer will notify the hardware sequencer of the defect (Step 130).

After initiating contact with the hardware sequencer, the embedded logic analyzer will proceed to transmit a defect event trigger notification to the hardware sequencer, the event trigger notification specifying the type of detected defect event conditions that are present. Thereafter, at step 135, the hardware sequencer accesses the stored defect event response code to initiate the remedial actions that are to be performed to correct the defect event or prevent further damage from the defect event. The hardware sequencer being interfaced with the IC's control registers subsequently writes instructions to the various control registers that will facilitate the performance of the required preventive or correction actions.

Within further aspects of the present invention, to enhance the capability of detecting the defects, multiple embedded logic analyzers could be configured in parallel within an IC to serve as defect event trigger logic. Further, to enhance the operational capabilities of the hardware sequencer to perform corrective/preventative actions, additional internal control latches, state machine latches and interface signal latches could be implemented in the IC chip as writable registers.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the real-time detection and prevention or correction of an error within an IC environment, the method further comprising the steps of:
determining at least one event, and at least one sequence of events set, wherein the at least one event, and the at least one sequence of events set serve as triggers for a defect event within an IC;
configuring a logic analyzer that is embedded within the IC to monitor the operations of the IC in order to detect occurrences of the at least one event, and the at least one sequence of events set within the IC;
monitoring an IC for an IC defect event trigger;
transmitting the IC defect trigger information from the embedded logic analyzer to an IC hardware sequencer; and
configuring the IC hardware sequencer to correct the defect event.

2. The method of claim 1, wherein the step of configuring the IC hardware sequencer to correct the detected at least one event or the at least one sequence of events set further comprises the step of the hardware sequencer writing commands to at least one determined control register to correct or prevent the detected defect event.

3. An IC configured for real-time internal error detection, the IC further comprising:
at least one embedded logic analyzer, wherein the at least one logic analyzer is configured to monitor the operations of the IC in order to detect occurrences of at least one event, and at least one sequence of events set within the IC, wherein the at least one event, and the at least one sequence of events set serve as triggers for a defect event within an IC; and
a hardware sequencer, the hardware sequencer being in electrical communication with the embedded logic analyzer, wherein the hardware sequencer is further configured to receive defect event trigger information from the embedded logic analyzer.

4. The IC of claim 3, where in response to receiving the defect event trigger information from the embedded logic analyzer, the hardware sequencer writes commands to at least one determined control register to correct or prevent the detected defect event.
